(19) United States
(12) Patent Application Publication
(10) Pub. No.: US 2010/0251087 A1
(43) Pub. Date: Sep. 30, 2010

(54) INFORMATION BROWSE APPARATUS

(75) Inventor: Kazuki MATSUI, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/732,273

(22) Filed: Mar. 26, 2010

(30) Foreign Application Priority Data
Mar. 30, 2009 (JP) 2009-082397

(51) Int. Cl. G06F 17/00; G06F 3/048

(52) U.S. Cl. 715/205; 715/784

(57) ABSTRACT

The information browse apparatus includes a display unit, an input unit, an information acquirer, and a display data constructor. The display unit has a display screen for displaying information. The input unit receives input information including location data of a point on a touch panel mounted on the display screen. The information acquirer acquires page information of a linked destination determined in accordance with the location data. The display data constructor updates display data currently displayed, so as to replace displayed content on a partial area of the display screen with a part of spread data of the page information. The partial area has been determined in accordance with the location data.

### CROSS-REFERENCE TO RELATED APPLICATION

This application is based upon and claims the benefit of priority of the prior Japanese Patent Application No. 2009-082397, filed on Mar. 30, 2009, the entire contents of which are incorporated herein by reference.

### FIELD

The embodiments discussed herein are related to an information browse apparatus, and in particular, to a method for controlling display of hypertext.

### BACKGROUND

Hypertext, typified by the World Wide Web (WWW or web), is a document in which link information to other documents is embedded. For example, by pointing, while browsing a web page, a location of a link source which is a word or the like in the web page, a linked web page is displayed to be browsed.

A portable device such as a cellular phone, a personal digital assistance (PDA), or a smart-phone may be configured to be capable of being mounted with a web browser (commonly referred to as a full browser) in which rich content for personal computers (PCs) may be browsed without change. Even with a portable device in a wireless communication environment in, for example, the outdoors or a business trip, web pages may be browsed through the Internet, using the full browser, as is the case with a PC.

Drifting page to page following links may make us get lost on the way home and search for an original web page. Thus, a primary operation is suspended until returning to the original web page is completed.

Methods to handle such a situation include a method employing an overlay display. In a method employing an overlay display, a linked web page is overlaid on the current web page while the current web page is displayed without completely switched to a display of the linked web page. With the overlay display, it may be easy to return to the original web page after drifting page to page following links, since the original web page remains displayed.

Japanese Laid-open Patent Publication No. 2003-345332 discloses a related technique.

### SUMMARY

According to an aspect of the present invention, provided is an information browse apparatus for displaying hypertext. The information browse apparatus includes a display unit, an input unit, an information acquirer, and a display data constructor.

The display unit has a display screen for displaying information.

The input unit receives input information including location data of a point on a touch panel mounted on the display screen.

The information acquirer acquires page information of a linked destination determined in accordance with the location data.

The display data constructor updates display data currently displayed, so as to replace displayed content on a partial area of the display screen with a part of spread data of the page information. The partial area has been determined in accordance with the location data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration of an information browse apparatus according to an embodiment of the present invention;

FIG. 2 is a diagram illustrating an example of a detailed configuration of a display data constructor of an information browse apparatus according to an embodiment of the present invention;

FIG. 3 is a diagram illustrating an example of an operation flow of an information browse apparatus according to an embodiment of the present invention;

FIGS. 4 to 7 are diagrams illustrating an example of operations for constructing display data performed by an information browse apparatus according to an embodiment of the present invention;

FIG. 8 is a diagram illustrating an example of a system configuration of an information browse apparatus according to an embodiment of the present invention;

FIG. 9 is a diagram illustrating an example of a detailed configuration of a display data constructor of an information browse apparatus according to an embodiment of the present invention;

FIG. 10 is a diagram illustrating an example of an operation flow of a process of displaying a dummy window performed by an information browse apparatus according to an embodiment of the present invention;

FIG. 11 is a diagram illustrating an example of a table for managing acquired amount of data employed in an information browse apparatus according to an embodiment of the present invention;

FIG. 12 is a diagram illustrating an example of a system configuration of an information browse apparatus according to an embodiment of the present invention;

FIG. 13 is a diagram illustrating an example of a detailed configuration of a display data constructor of an information browse apparatus according to an embodiment of the present invention; and

FIG. 14 is a diagram illustrating an example of an operation flow of a reservation process performed by an information browse apparatus according to an embodiment of the present invention.

### DESCRIPTION OF EMBODIMENTS

Since a display screen of a portable device is smaller or the resolution is lower compared with a PC, performing overlay display on a portable device may cause inconvenience. When displaying whole of a web page on a portable device, the web page may be zoomed out. An overlay display may make a zoomed out web page illegible. When displaying a web page without zooming out, only a part of the web page is displayed. An overlay display of a part of a web page may make it difficult to recognize what is displayed. In either case, since a primary work, browsing a web page, is hindered, a display screen of a portable device poses a problem of maintaining continuity of user's work.

According to an embodiment of the present invention, a linked web page is displayed only in a display area depending on a location of a link source. Since an original web page remains and the linked web page is also displayed clearly, user's work may be continued without being suspended.

Embodiments of the present invention will now be discussed with reference to the drawings.

### First Embodiment

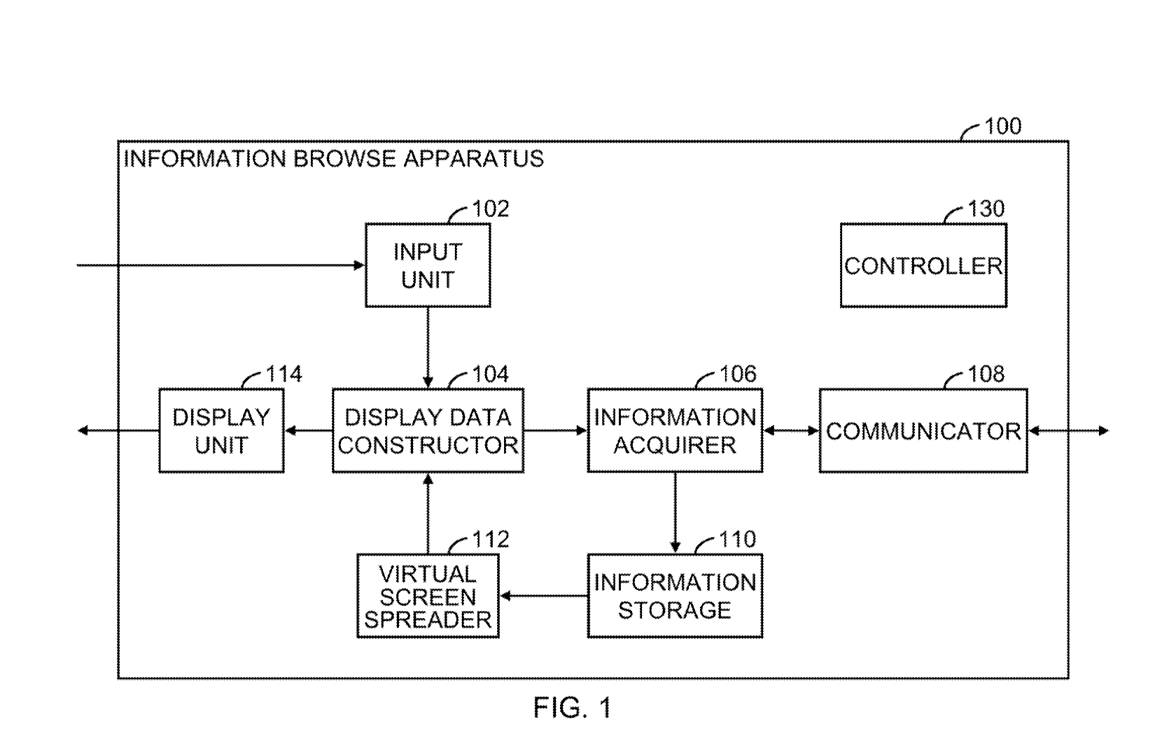

FIG. 1 is a diagram illustrating an example of a system configuration of an information browse apparatus according to an embodiment of the present invention. As illustrated in FIG. 1, an information browse apparatus 100 includes an input unit 102, a display data constructor 104, an information acquirer 106, a communicator 108, an information storage 110, a virtual screen spreader 112, a display unit 114, and a controller 130. The information browse apparatus 100 is capable of communicating with a content server (not illustrated) via a communication network.

The input unit 102 receives input information input from a user and sends the input information to the display data constructor 104. The input information includes, for example, location data of a specific point on a touch panel mounted on a display screen, time data, and pressure data acquired when the user touches the specific point, using his finger or a pen (referred to as a touch pen) for the touch panel.

The display data constructor 104 determines an address of a linked destination in accordance with the input information received from the input unit 102 and sends the determined address of the linked destination to the information acquirer 106 to request the information acquirer 106 to acquire information (referred to as page information) of a web page. The display data constructor 104 further constructs display data on the basis of spread data, which is spread for a virtual screen, generated by the virtual screen spreader 112. Thus, the display data constructor 104 updates display data currently displayed, so as to replace displayed content on a partial area (referred to as a partial window) of the display screen with a part of spread data of the page information. The partial area has been determined in accordance with the location data.

The information acquirer 106 generates a command for acquiring page information, specifying the address of the linked destination received from the display data constructor 104, and sends the command to the communicator 108. The information acquirer 106 receives, from the communicator 108, the page information received from the content server and stores the received page information in the information storage 110.

The communicator 108 sends the command to the content server via a communication network. The communicator 108 further receives the page information from the content server via the communication network and sends the received page information to the information acquirer 106.

The virtual screen spreader 112 generates spread data for displaying the page information on a virtual screen supposed to be a PC screen, in accordance with the page information stored in the information storage 110.

The display unit 114 includes the display screen smaller than the virtual screen. The display unit 114 displays the spread data within a display area corresponding to a screen size of the display screen.

The controller 130 controls the whole of the information browse apparatus 100. It is assumed that the controller 130 performs all functions that are not explicitly discussed in the specification, out of functions performed by the information browse apparatus 100.

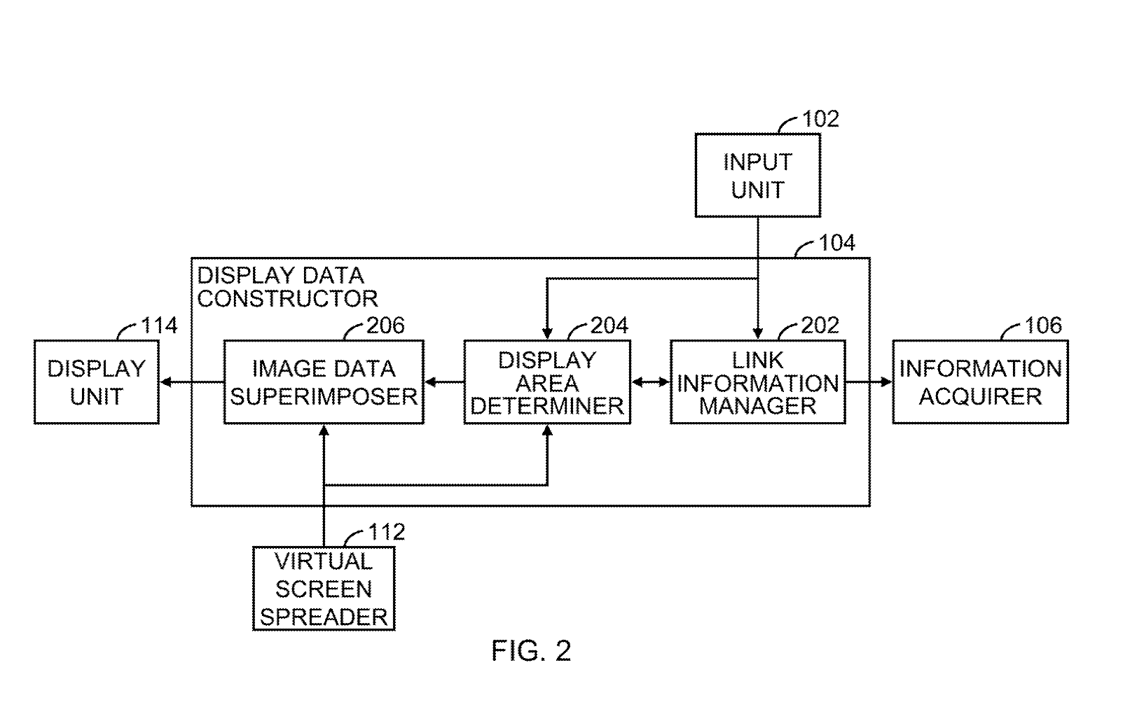

FIG. 2 is a diagram illustrating an example of a detailed configuration of a display data constructor of an information browse apparatus according to an embodiment of the present invention. As illustrated in FIG. 2, the display data constructor 104 includes a link information manager 202, a display area determiner 204, and an image data superimposer 206.

The link information manager 202 determines a link source which is a word or the like in accordance with location data included in the input information, determines a display location of the determined link source on a display screen, and notifies the display area determiner 204 of the display location. The link information manager 202 further determines an address of a linked destination in accordance with the location data included in the input information and notifies the information acquirer 106 of the address.

The display area determiner 204 determines a display area of a linked web page. The display area determiner 204 further determines, in accordance with the location data included in the input information, a location of a temporary window for displaying the linked web page.

The image data superimposer 206 generates image data in which the linked web page is superimposed within the determined temporary window on a web page that is currently displayed.

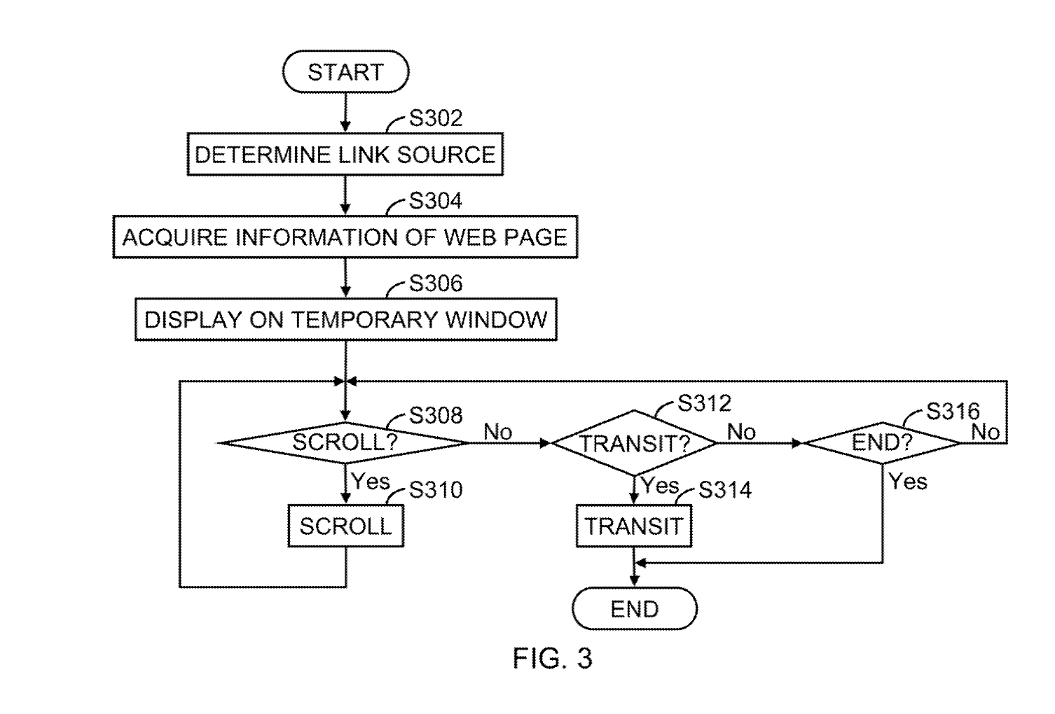

FIG. 3 is a diagram illustrating an example of an operation flow of an information browse apparatus according to an embodiment of the present invention. The operation flow of the information browse apparatus according to the first embodiment of the present invention will be discussed with reference to FIG. 3.

It is assumed that a certain web page (referred to as a home) is already displayed on a display screen, and the following operations are performed when the user points a link included in the home.

In operation S302, the information browse apparatus 100 determines a link source as follows. When the user has touched with his finger or a touch pen, on a touch panel mounted on the display screen, a link source which is a word or the like included in the web page displayed on the display screen, the input unit 102 detects the touch, acquires location data of a touched location, and sends the acquired location data to the link information manager 202. The link information manager 202 determines the link source in accordance with the location data received from the input unit 102 and determines the display location of the link source on the display screen.

In operation S304, the information browse apparatus 100 acquires page information as follows. The link information manager 202 acquires an address of a linked destination corresponding to the determined link source and sends the address to the information acquirer 106. The information acquirer 106 acquires the information of a web page corresponding to the address of the linked destination from the content server via the communicator 108. The information acquirer 106 stores the acquired page information in the information storage 110.

In operation S306, the information browse apparatus 100 displays information of a linked web page on a temporary window as follows. The virtual screen spreader 112 generates spread data to be displayed on the display screen, in accordance with the page information stored in the information storage 110. The generated spread data is referred to from the display area determiner 204 and the image data superimposer 206. The display area determiner 204 determines a display area to be displayed on the display screen, out of the spread data. The display area determiner 204 further determines a location of a temporary window for displaying the linked web page depending on the display location of the link source which is the word or the like on the display screen. The image data superimposer 206 generates new display data by superimposing, on the display data of the home, which is currently displayed on the display screen, data for displaying the linked web page within the temporary window. The display unit 114 displays the generated display data on the display screen.

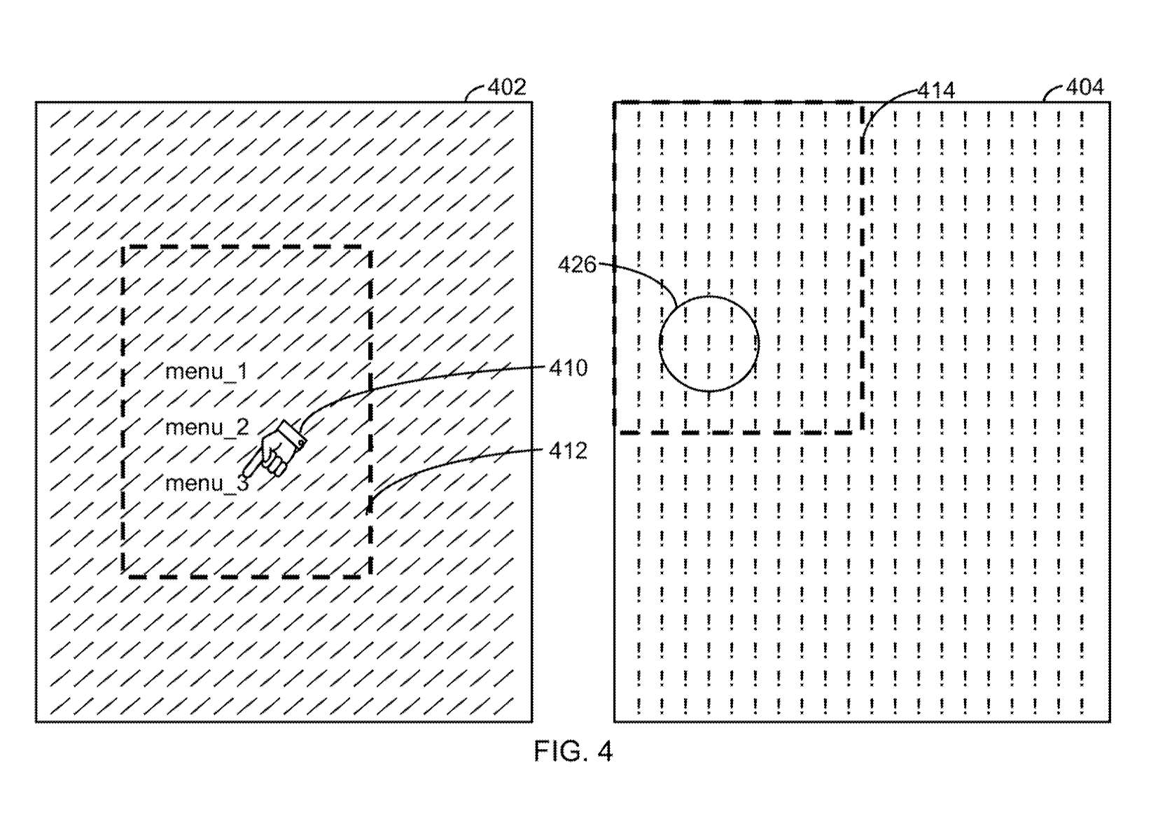

FIGS. 4 to 7 are diagrams illustrating an example of operations for constructing display data performed by an information browse apparatus according to an embodiment of the present invention. It is assumed that spread data 402 within a display area 412 illustrated in FIG. 4 is displayed on the display screen. When the user has touched a link source (“menu_{—}3” in the example illustrated in FIG. 4) in the display area 412, with his finger 410 or a touch pen, information of a linked web page corresponding to the link source “menu_{—}3” is acquired, and spread data 404 of the acquired page information is generated. When the spread data 404 is displayed on the display screen for the first time, for example, the upper left area of the spread data 404, i.e., a display area 414, is displayed. In this case, the whole of the display area 414 is not displayed, but only data within a temporary window 426 is superimposed on a display of the display area 412. The temporary window 426 corresponding to the display location of the link source “menu_{—}3” in the display area 412 is provided within the display area 414. Although the temporary window is circular in the example illustrated in FIG. 4, the temporary window may have any shape, for example, it may be elliptic or rectangular. The size of the temporary window is assumed to be predetermined.

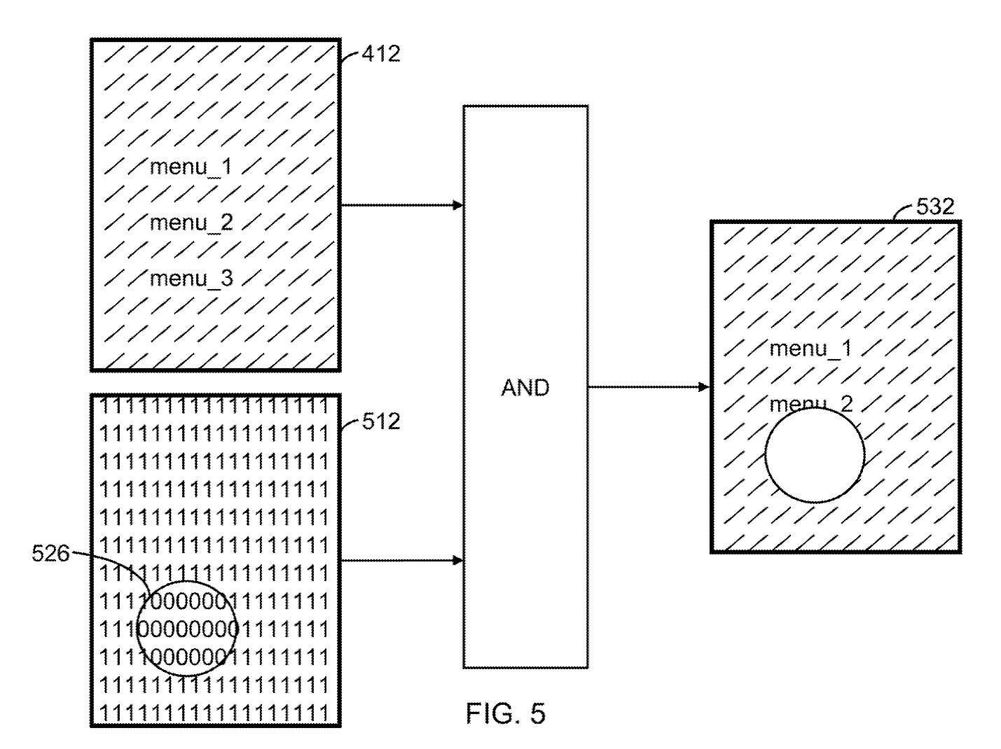

The operations of superimposing display data will next be discussed. A mask pattern 512 illustrated in FIG. 5 is an area having the same size as the display area 412. In the mask pattern 512, each pixel value within a temporary window 526 corresponding to the temporary window 426 is set to zero, and each pixel value outside the temporary window 526 is set to one. By performing AND operation, for each pixel, on data in the display area 412 with data in the mask pattern 512, home data 532 is obtained.

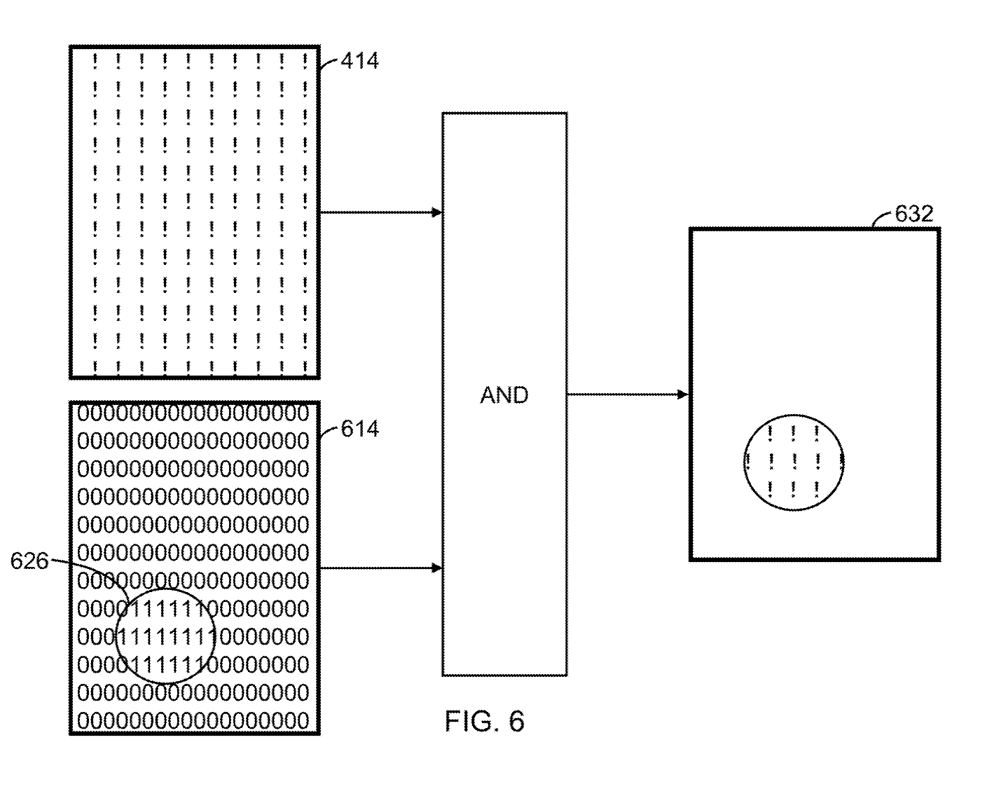

A mask pattern 614 illustrated in FIG. 6 is an area having the same size as the display area 414. In the mask pattern 614, each pixel value within a temporary window 626 corresponding to the temporary window 426 is set to one, and each pixel value outside the temporary window 626 is set to zero. By performing AND operation, for each pixel, on data in the display area 414 with data in the mask pattern 614, linked destination data 632 is obtained.

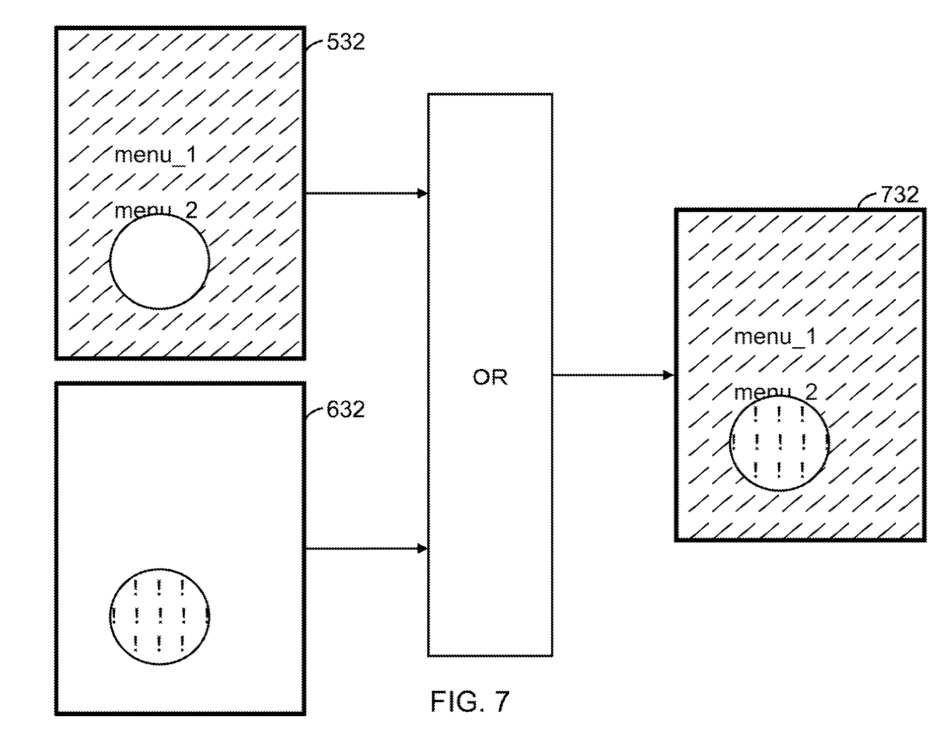

By performing OR operation, for each pixel, on data in the home data 532 with data in the linked destination data 632, superimposed data 732 is obtained, as illustrated in FIG. 7.

Thus, the superimposed data 732 is displayed on the display screen.

In operation S308, the display area determiner 204 checks whether the user has issued an instruction for scrolling. The user may employ any method of instruction for scrolling. For example, the user may draw, using his finger or a touch pen, a straight line within a partial area in the direction of scrolling on the touch panel mounted on the display screen.

In operation S310, when the user has issued an instruction for scrolling within the temporary window (“Yes” in operation S308), the scrolling is performed. That is, the display data constructor 104 updates the display data currently displayed, so as to scroll the spread data within the partial area in the specified direction as follows. The display area determiner 204 shifts the display area 414 within the spread data 404 in response to the instruction for scrolling and superimposes, on the display area 412, data within the temporary window 426 shifted along with the shift of the display area 414 so as to be displayed.

In operation S312, when the user has not issued instruction for scrolling within the temporary window (“No” in operation S308), the display area determiner 204 checks whether the user has issued an instruction for transition of a web page. Transition means setting a web page that is currently displayed within the temporary window as a home. That is, the whole of the display area 414 of the web page, which is currently displayed within the temporary window, is displayed on the display screen. The user may employ any method of instruction for transition of a web page. For example, the user may continue to press the touch panel for over a predetermined period to issue an instruction for transition. Alternatively, the user may press the touch panel with over predetermined pressure to issue an instruction for transition.

In operation S314, when the user has issued an instruction for transition of a web page (“Yes” in operation S312), the transition is performed. That is, the display area determiner 204 constructs display data such that the whole of the display area 414 is displayed on the display screen. Before the whole of the display area 414 is displayed on the display screen, the display screen may be sequentially constructed so that the temporary window increases in size in stages.

In operation S316, when the user has not issued an instruction for transition of a web page (“No” in operation S312), the display area determiner 204 checks whether the user has issued an instruction for terminating display of the linked web page. When the user has not issued an instruction for terminating display of the linked web page (“No” in operation S316), the information browse apparatus 100 returns the process to operation S308. When the user has issued an instruction for terminating display of the linked web page on the temporary window (“Yes” in operation S316), the information browse apparatus 100 terminates the process. The user may employ any method of instruction for terminating display of the linked web page. For example, the user may withdraw his finger from the touch panel to terminate display of the linked web page on the temporary window.

As discussed above, according to the first embodiment of the present invention, when the user has selected a link source which is a word or the like, the information browse apparatus provides, while maintaining the current display, a temporary window for displaying a part of a linked web page near a location where the link source is displayed, and scrolls, for example, the linked web page in the temporary window. Thus, it may be easy for the user to recognize where an original web page is, since the user just temporarily browses the linked web page through the temporary window. Since both the original web page and the linked web page are shown clearly, the user may continue to browse a web page without being suspended even on a small or low-resolution display screen such as that of a portable device.

While the page information is acquired from a content server via a communication network in the aforementioned example, the aforementioned method for controlling display of information may be employed in the case where the user browses, following a link, information stored within the information browse apparatus.

### Second Embodiment

When a portable device is used in a wireless communication environment, it may often take time to acquire a web page depending on a status of the wireless communication environment. A user may become uncertain about what the user is currently doing while waiting for display of an acquired web page. This also causes a disturbance in maintaining continuity of user's work in browsing a web page.

An information browse apparatus according to a second embodiment of the present invention enables a user to readily learn, when it takes time to acquire a web page, that the web page is being currently acquired and how much data has been already acquired.

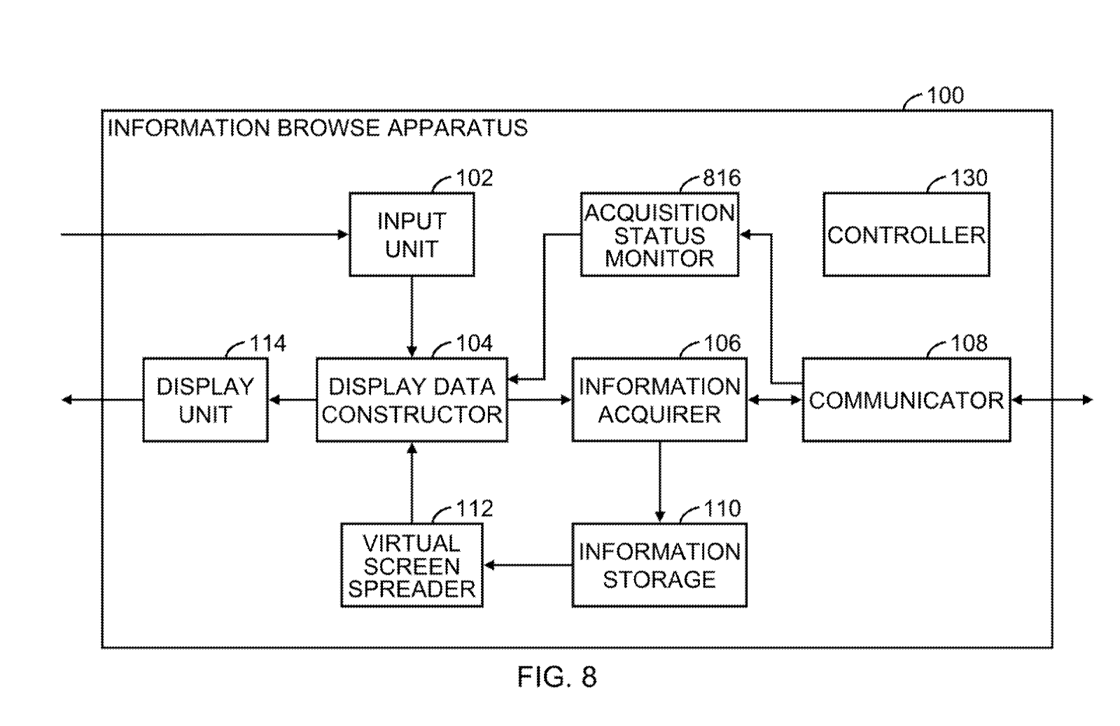

FIG. 8 is a diagram illustrating an example of a system configuration of an information browse apparatus according to an embodiment of the present invention. In the example of the system configuration of the information browse apparatus according to the second embodiment illustrated in FIG. 8, an acquisition status monitor 816 is added to the example of the system configuration of the information browse apparatus according to the first embodiment illustrated in FIG. 1.

The acquisition status monitor 816 monitors a status of acquiring information of a linked web page to be received by the information acquirer 106 via the communicator 108 and notifies the status of acquiring information of the linked web page to the display data constructor 104.

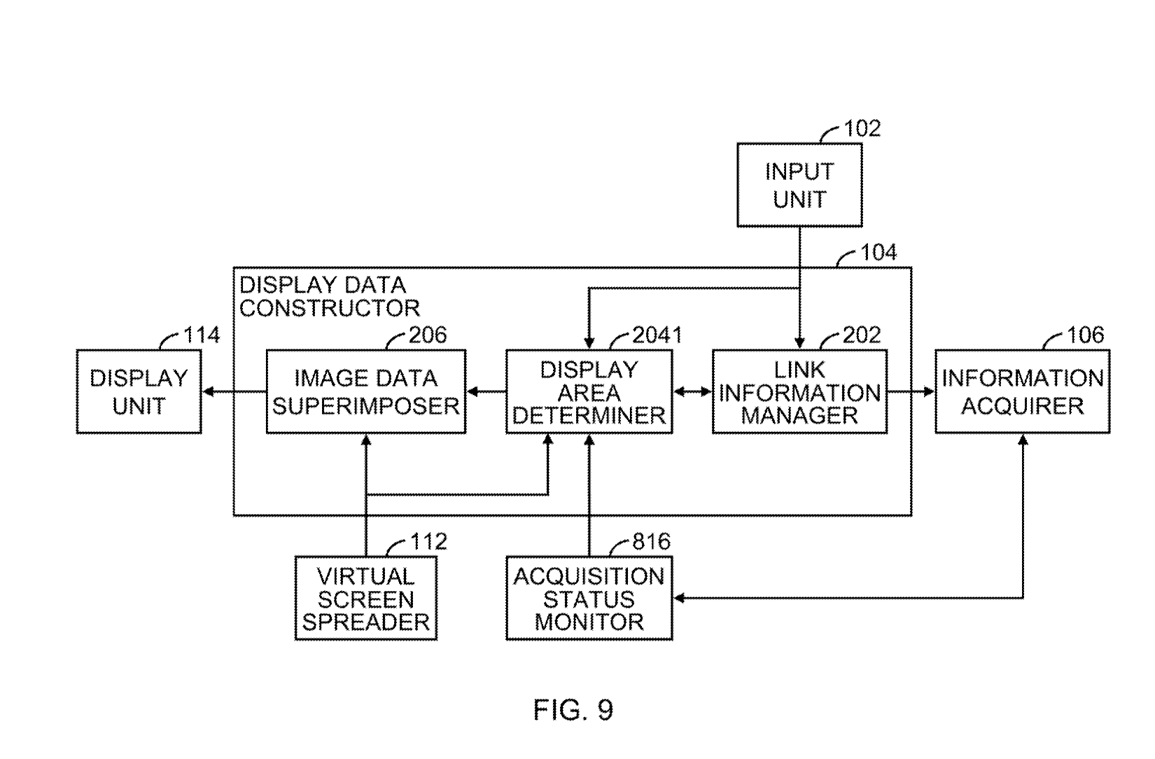

FIG. 9 is a diagram illustrating an example of a detailed configuration of a display data constructor of an information browse apparatus according to an embodiment of the present invention. In the detailed configuration of the display data constructor of the information browse apparatus according to the second embodiment, like reference numerals in the detailed configuration of the display data constructor of the information browse apparatus according to the first embodiment illustrated in FIG. 2 are assigned to like components, and the discussion of these components will be omitted. A display area determiner 2041 according to the second embodiment instructs the image data superimposer 206 to display a dummy temporary window (also referred to as a dummy window) in accordance with the status of acquiring information of a linked web page received from the acquisition status monitor 816.

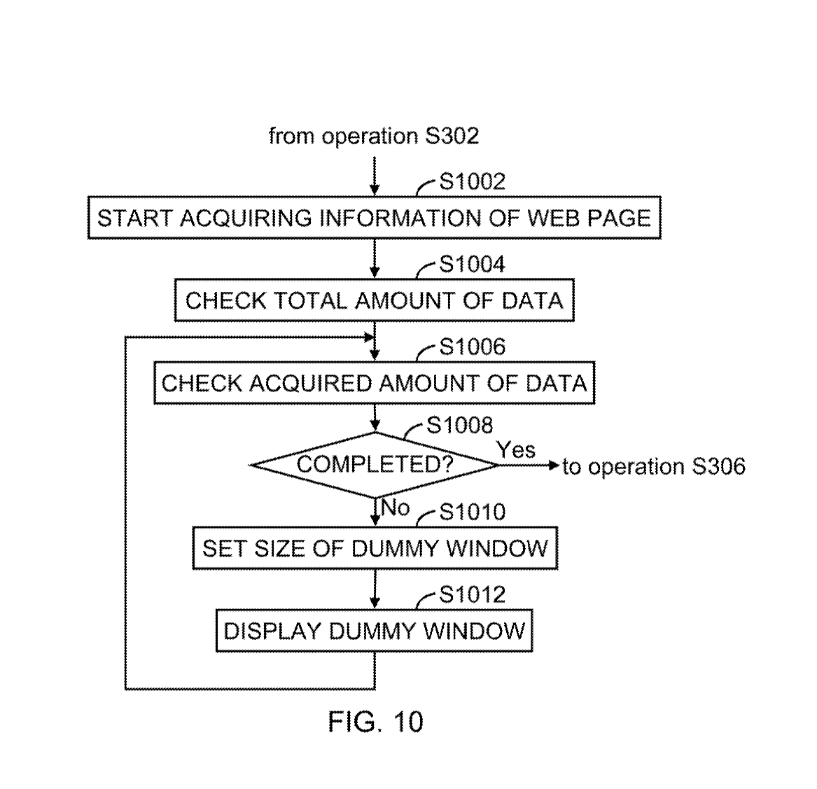

FIG. 10 is a diagram illustrating an example of an operation flow of a process of displaying a dummy window performed by an information browse apparatus according to an embodiment of the present invention. The process of displaying a dummy window performed by the information browse apparatus according to the second embodiment is added to operation S304, that is, the operation of acquiring page information, in the operation flow of the information browse apparatus according to the first embodiment illustrated in FIG. 3.

In operation S1002, the communicator 108 starts the process of acquiring page information.

In operation S1004, the acquisition status monitor 816 checks a total amount of data of a web page to be acquired as follows. The acquisition status monitor 816 monitors the status of acquiring page information received by the communicator 108 and records the status in a table for managing acquired amount of data. When the process of acquiring information of a new linked web page is started, the acquisition status monitor 816 generates a new record of the table for managing acquired amount of data, setting the address of the linked web page as a key.

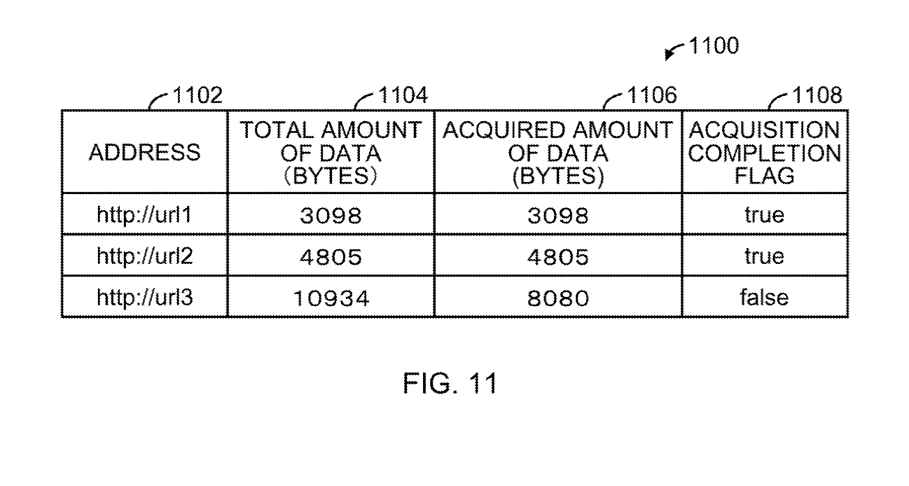

FIG. 11 is a diagram illustrating an example of a table for managing acquired amount of data employed in an information browse apparatus according to an embodiment of the present invention. Each record of a table 1100 for managing acquired amount of data includes an “address” field 1102, a “total amount of data” field 1104, an “acquired amount of data” field 1106, and an “acquisition completion flag” field 1108. When the acquisition status monitor 816 generates a new record of the table 1100 for managing acquired amount of data, the acquisition status monitor 816 stores an address of a linked destination in the “address” field 1102 of the generated record, checks a total amount of data of a web page to be acquired, and stores the total amount of data in the “total amount of data” field 1104. A specific method for checking total amount of data is, for example, to acquire a total amount of data from the header information of a data file of page information. The acquisition status monitor 816 sets a flag in the “acquisition completion flag” field 1108 to “false” which indicates that acquisition of the page information has not been completed.

In operation S1006, the acquisition status monitor 816 monitors the status of acquiring page information acquired by the information acquirer 106 via the communicator 108 to check the amount of data acquired so far and stores the amount in the “acquired amount of data” field 1106 of the generated record.

In operation S1008, the acquisition status monitor 816 checks whether all the data has been acquired. When all the data has been acquired (“Yes” in operation S1008), the acquisition status monitor 816 sets the flag in the “acquisition completion flag” field 1108 of the generated record to “true” which indicates that acquisition of the page information has been completed. Thereafter, the information browse apparatus 100 advances the process to operation S306 in FIG. 3.

In operation S1010, when a part of the data has not been yet acquired (“No” in operation S1008), the display area determiner 2041 sets a size of a dummy window. Any method for setting the size of the dummy window may be employed. It is preferable that, the larger the acquired amount of data is, the larger the size of the dummy window is. For example, the size of the dummy window may be set such that the ratio of the area of the dummy window to the area of the temporary window matches with the ratio of the acquired amount of data to the total amount of data. Specifically, the display area determiner 2041 calculates a ratio of a value of the “acquired amount of data” field 1106 to a value of the “total amount of data” field 1104, for a record, which has “false” in the “acquisition completion flag” field 1108, of the table 1100 for managing acquired amount of data. In the example illustrated in FIG. 11, 8080/10934≈0.73 is obtained as the ratio of the value in the “acquired amount of data” field 1106 to the value in the “total amount of data” field 1104. The display area determiner 2041 sets the size of the dummy window to be 0.85 (the square root of 0.73) times as large as the size of the temporary window so that the area of the dummy window is about 0.73 times as large as the area of the temporary window.

In operation S1012, the dummy window is displayed as follows. The display area determiner 2041 constructs display data by superimposing the dummy window of the set size on a display area. The dummy window does not show the web page but only some patterns or words such as “data is being acquired”. Alternatively, information indicating the ratio of the acquired amount of data to the total amount of data may be displayed in the dummy window. After the dummy window is displayed, the information browse apparatus 100 returns the process to operation S1006.

By repeating operation S1006 and the following operations, a dummy window of a size corresponding to acquired amount of data is displayed as acquisition of the information proceeds. Thus, the display data constructor 104 updates the display data currently displayed, so as to replace displayed content on a partial area of the display screen with display content representing that the page information is being acquired. The size of the partial area is determined in accordance with a ratio of acquired page information.

As discussed above, according to the second embodiment, since a dummy window of a size corresponding to acquired amount of data is displayed as acquisition of the information proceeds while acquiring page information, the user may learn that acquiring page information is currently continuing and further may learn what percentage of data has been acquired. Thus, continuity of user's work in browsing a web page may be maintained, since the user may clearly confirm what the user is currently doing.

### Third Embodiment

When a portable device is used in a wireless communication environment, acquisition of information of a linked web page may often fail depending on a status of the wireless communication environment. Thus, a user attempts to acquire the information of the same web page many times. This also causes a disturbance in maintaining continuity of user's work in browsing a web page.

When acquisition of page information has failed, an information browse apparatus according to a third embodiment of the present invention accepts a reservation for acquisition of the page information and performs the reserved acquisition in the background. After acquisition of the page information has been completed, the information browse apparatus notifies the user of the completion of acquisition and displays the linked web page upon receiving an instruction for display from the user.

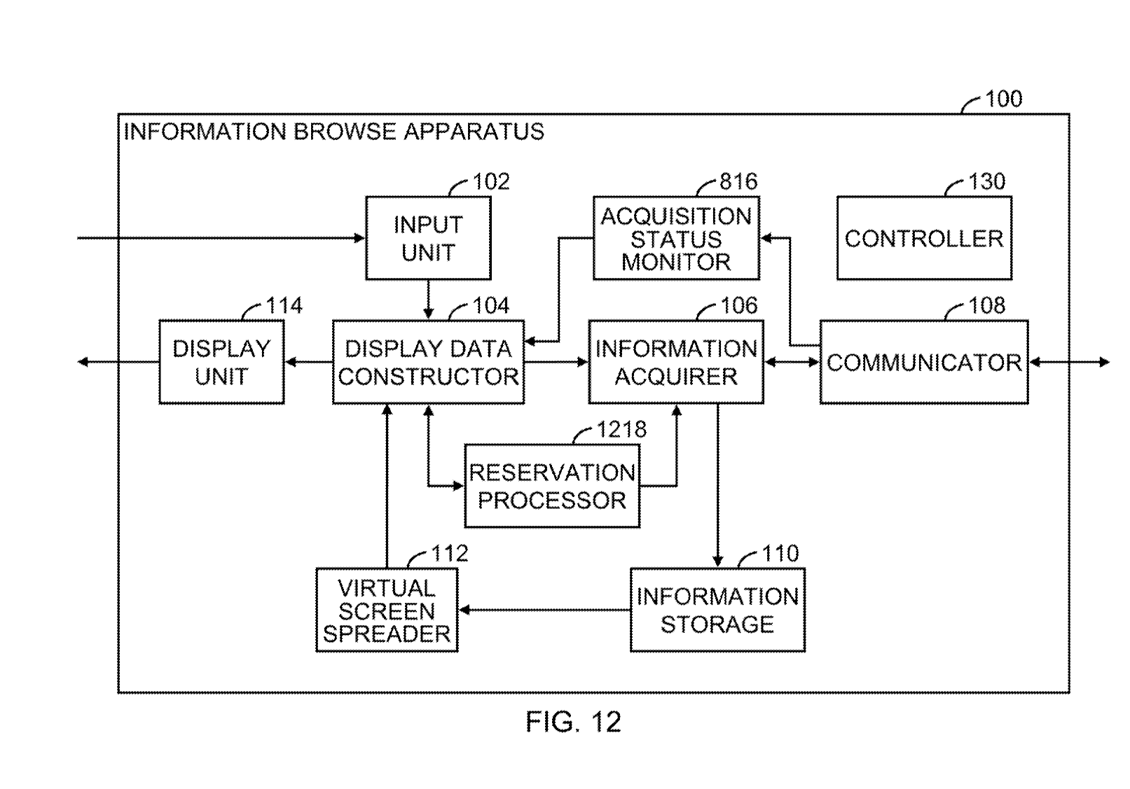

FIG. 12 is a diagram illustrating an example of a system configuration of an information browse apparatus according to an embodiment of the present invention. In the example of the system configuration of the information browse apparatus according to the third embodiment illustrated in FIG. 12, a reservation processor 1218 is added to the example of the system configuration of the information browse apparatus according to the second embodiment illustrated in FIG. 8.

The reservation processor 1218 acquires page information in the background in response to, for example, an instruction to acquire the page information from a user.

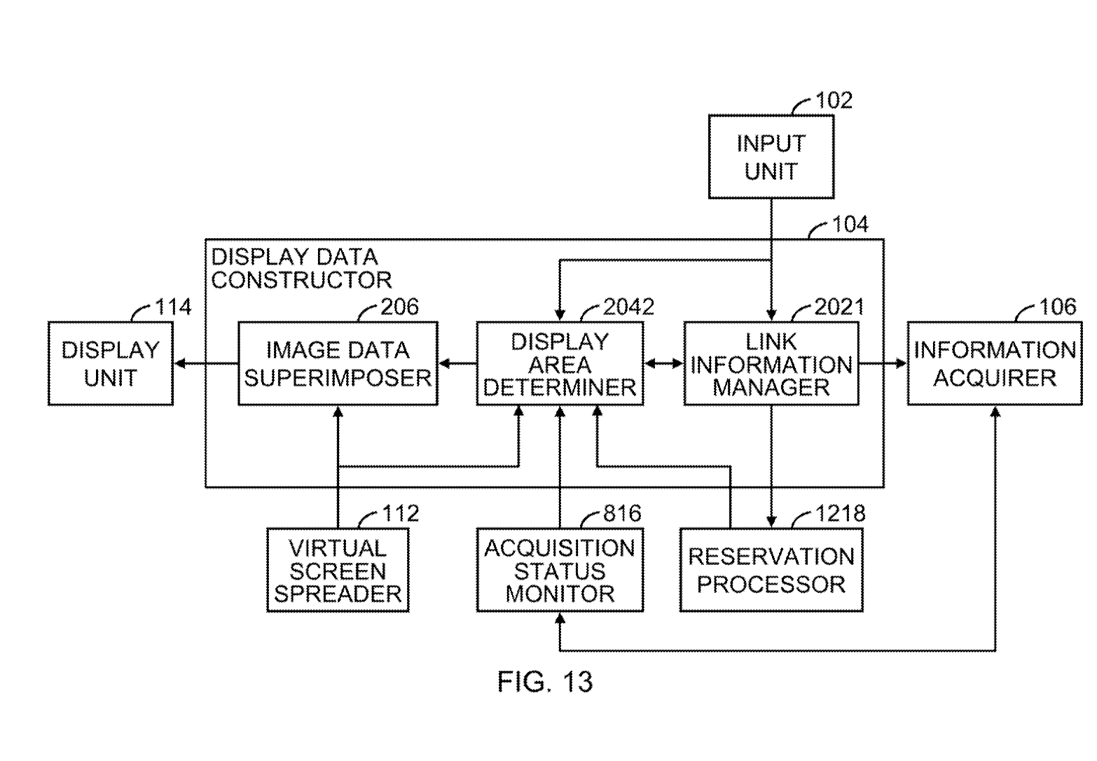

FIG. 13 is a diagram illustrating an example of a detailed configuration of a display data constructor of an information browse apparatus according to an embodiment of the present invention. In the detailed configuration of the display data constructor of the information browse apparatus according to the third embodiment, like reference numerals in the detailed configuration of the display data constructor of the information browse apparatus according to the second embodiment illustrated in FIG. 9 are assigned to like components, and the discussion of these components will omitted. A link information manager 2021 according to the third embodiment instructs the reservation processor 1218 to acquire page information in the background. A display area determiner 2042 manages displays related to a reservation process in response to an instruction from the reservation processor 1218.

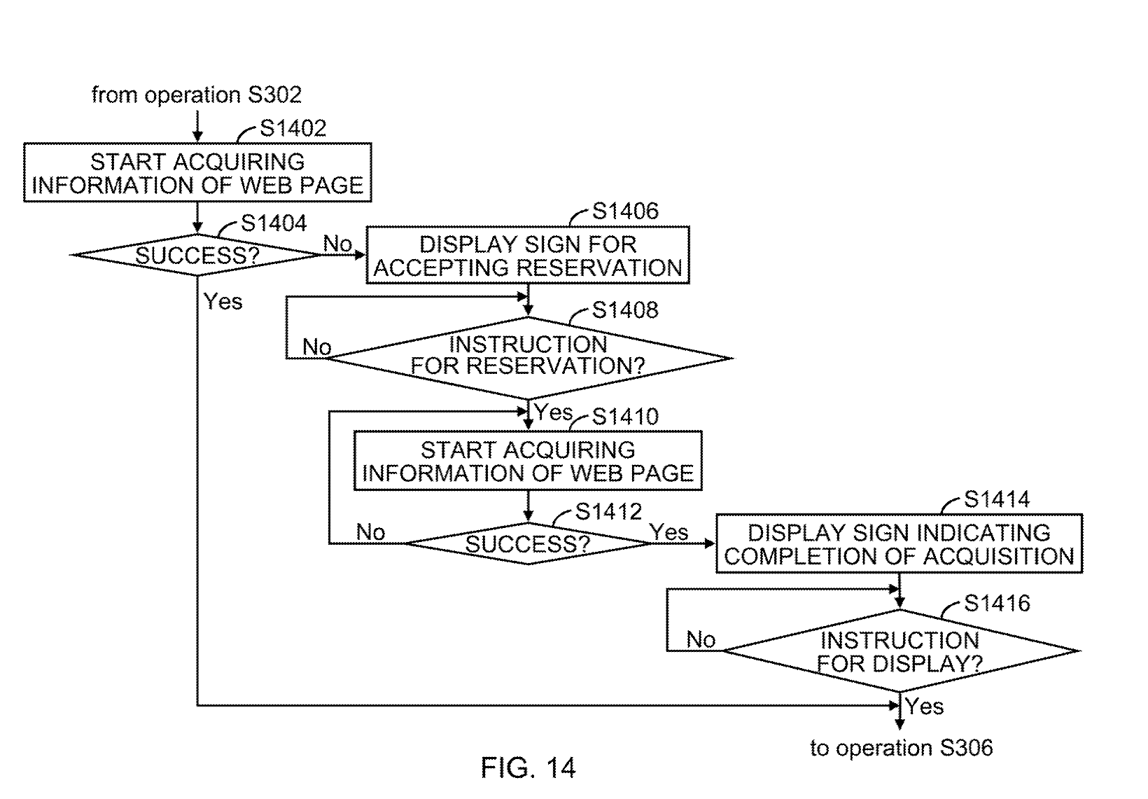

FIG. 14 is a diagram illustrating an example of an operation flow of a reservation process performed by an information browse apparatus according to an embodiment of the present invention. The reservation process performed by the information browse apparatus according to the third embodiment is added to operation S304, that is, the operation of acquiring page information, in the operation flow of the information browse apparatus according to the first embodiment illustrated in FIG. 3.

In operation S1402, the communicator 108 starts the process of acquiring page information in response to an instruction from the information acquirer 106.

In operation S1404, the acquisition status monitor 816 checks whether the process of acquiring page information has been successfully completed. When the process of acquiring page information has been successfully completed (“Yes” in operation S1404), the information browse apparatus 100 does not perform the reservation process.

In operation S1406, when the process of acquiring page information has not been successfully completed (“No” in operation S1404), the link information manager 2021 requests the reservation processor 1218 to perform the reservation process. The display data constructor 104 displays, on the display unit 114, a sign indicating that a reservation is available in response to a request from the reservation processor 1218 as follows. The reservation processor 1218 requests the display area determiner 2042 to construct display data of the sign indicating that a reservation is available. The display area determiner 2042 constructs display data so as to provide the sign indicating that a reservation is available. The display area determiner 2042 may employ any method for providing a sign indicating that a reservation is available as long as the user may recognize that the status differs from a normal status. For example, a mark (for example, a cross “x”) indicating that acquisition of the page information has failed may be displayed near the link source. Alternatively, display color of the link source may be changed. Alternatively yet, any mark indicating that reservation is available may be displayed.

In operation S1408, the reservation processor 1218 waits for an instruction for reservation from the user. The user may issue an instruction for reservation by, for example, clicking the sign indicating that a reservation is available. The reservation processor 1218 detects the click operation. When no instruction for reservation has been issued from the user (“No” in operation S1408), the reservation processor 1218 continues waiting for an instruction for reservation. Waiting for an instruction for reservation may be canceled, and the reservation process may be terminated when, for example, the home is changed due to the transition of a web page.

In operation S1410, when an instruction for reservation has been issued from the user (“Yes” in operation S1408), the reservation processor 1218 requests the information acquirer 106 to acquire page information. The information acquirer 106 starts the process of acquiring page information. The reservation processor 1218 requests the display area determiner 2042 to display, on the display unit 114, a sign indicating that the process of acquiring page information is ongoing in the background. Upon receiving the request from the reservation processor 1218, the display area determiner 2042 displays, on the display unit 114, the sign indicating that the process of acquiring page information is ongoing in the background. The display area determiner 2042 may employ any method for displaying a sign indicating that the process of acquiring page information is ongoing in the background. The display area determiner 2042 may provide, for example, a sign in which a mark, a character, a color, blinking, or the like distinguishable from others is employed.

In operation S1412, the acquisition status monitor 816 checks whether the process of acquiring page information has been successfully completed. When the process of acquiring page information has not been successfully completed (“No” in operation S1412), the reservation processor 1218 requests again the information acquirer 106 to perform the process of acquiring page information. The reservation processor 1218 may issue the request without delay or after waiting a predetermined period. Alternatively, the reservation processor 1218 may adjust the timing of issuing the request depending traffic of the communication network.

In operation S1414, when the process of acquiring page information has been successfully completed (“Yes” in operation S1412), the reservation processor 1218 requests the display area determiner 2042 to display, on the display unit 114, a sign indicating that acquisition of the page information has been completed. Upon receiving the request from the reservation processor 1218, the display area determiner 2042 displays, on the display unit 114, the sign indicating that acquisition of the page information has been completed. The display area determiner 2042 may employ any method for displaying a sign indicating that acquisition of the page information has been completed. The display area determiner 2042 may provide, for example, a sign in which a mark, a character, a color, blinking, or the like distinguishable from others is employed.

In operation S1416, the reservation processor 1218 waits for an instruction for display from the user. The user may issue an instruction for display by, for example, clicking the sign indicating that acquisition of the page information has been completed. The reservation processor 1218 detects the click operation. When an instruction for display has been issued from the user (“Yes” in operation S1416), the reservation processor 1218 terminates its process, and the information browse apparatus 100 advances the process to operation S306. There, display data constructor 104 updates display data currently displayed, so as to replace displayed content on the temporary window with a part of the spread data.

As discussed above, according to the third embodiment, upon failing to acquire page information, the information browse apparatus 100 may shift to the mode of automatic acquisition in the background. Thus, continuity of user's work in browsing a web page may be maintained, since the user need not repeat attempting to display the web page many times. In the aforementioned example, the user issues the instruction for reservation when acquisition of information of the linked web page has failed. Alternatively, the reservation process may be automatically performed when a failure in acquiring information of the linked web page has been detected.

The information browse apparatus according to the embodiments of the present invention may be implemented as hardware or software for computers. For example, the information browse apparatus 100 may be implemented by generating a program for causing a computer to perform the respective functions of the input unit 102, the display data constructor 104, the information acquirer 106, the communicator 108, the information storage 110, the virtual screen spreader 112, the display unit 114, and the controller 130 illustrated in FIG. 1, loading the program into a memory of a computer, and causing the computer to execute the program.

The components of the information browse apparatus according to the embodiment of the present invention may be provided in any combination. A plurality of components may be provided as a single member, or a single component may be composed of a plurality of members.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information browse apparatus for displaying hypertext, the information browse apparatus comprising:
a display unit having a display screen for displaying information;
an input unit that receives input information including location data of a point on a touch panel mounted on the display screen;
an information acquirer that acquires page information of a linked destination determined in accordance with the location data; and
a display data constructor that updates display data currently displayed, so as to replace displayed content on a partial area of the display screen with a part of spread data of the page information, the partial area being determined in accordance with the location data.

2. The information browse apparatus according to claim 1, wherein
when the input unit has received input information including data indicating a direction on the display screen, the display data constructor updates the display data currently displayed, so as to scroll the spread data within the partial area in the direction.

3. The information browse apparatus according to claim 1, wherein
while the page information is being acquired, the display data constructor updates the display data currently displayed, so as to replace displayed content on a partial area of the display screen with display content representing that the page information is being acquired, a size of the partial area being determined in accordance with a ratio of acquired page information.

4. The information browse apparatus according to claim 1, wherein
when the information acquirer has acquired page information of a linked destination determined in accordance with a first location data included in first input information received by the input unit, and the input unit has received second input information including second location data corresponding to the linked destination,
the display data constructor updates display data currently displayed, so as to replace displayed content on a partial area of the display screen with a part of the spread data, the partial area being determined in accordance with the first location data.

5. A control method for controlling display of hypertext, the control method being executed by an information browse apparatus, the control method comprising:
receiving input information including location data of a point on a touch panel mounted on a display screen;
acquiring page information of a linked destination determined in accordance with the location data; and
updating, by the information browse apparatus, display data currently displayed, so as to replace displayed content on a partial area of a display screen with a part of spread data of the page information, the partial area being determined in accordance with the location data.

6. The control method according to claim 5, wherein
upon receiving input information including data indicating a direction on the display screen, the information browse apparatus updates the display data currently displayed, so as to scroll the spread data within the partial area in the direction.

7. The control method according to claim 5, wherein
while the page information is being acquired, the information browse apparatus updates the display data currently displayed, so as to replace displayed content on a partial area of the display screen with display content representing that the page information is being acquired, a size of the partial area being determined in accordance with a ratio of acquired page information.

8. The control method according to claim 5, wherein
upon acquiring page information of a linked destination determined in accordance with a first location data included in first input information, and receiving second input information including second location data corresponding to the linked destination,
the information browse apparatus updates display data currently displayed, so as to replace displayed content on a partial area of the display screen with a part of the spread data, the partial area being determined in accordance with the first location data.

9. A computer-readable medium storing a program to control display of hypertext, the program causing a computer to execute:
receiving input information including location data of a point on a touch panel mounted on a display screen,
acquiring page information of a linked destination determined in accordance with the location data, and
updating display data currently displayed, so as to replace displayed content on a partial area of a display screen with a part of spread data of the page information, the partial area being determined in accordance with the location data.

10. The computer-readable medium according to claim 9, wherein
upon receiving input information including data indicating a direction on the display screen, the information browse apparatus updates the display data currently displayed, so as to scroll the spread data within the partial area in the direction.

11. The computer-readable medium according to claim 9, wherein
while the page information is being acquired, the information browse apparatus updates the display data currently displayed, so as to replace displayed content on a partial area of the display screen with display content representing that the page information is being acquired, a size of the partial area being determined in accordance with a ratio of acquired page information.

12. The computer-readable medium according to claim 9, wherein
upon acquiring page information of a linked destination determined in accordance with a first location data included in first input information, and receiving second input information including second location data corresponding to the linked destination,
the information browse apparatus updates display data currently displayed, so as to replace displayed content on a partial area of the display screen with a part of the spread data, the partial area being determined in accordance with the first location data.
